(19) United States
(12) Patent Application Publication
(10) Pub. No.: US 2015/0324208 A1
(43) Pub. Date: Nov. 12, 2015

(54) FAST STARTUP BEHAVIOR CONTROL OF A CPU

(71) Applicant: Texas Instruments Deutschland GMBH, Freising (DE)

(72) Inventors: Christian Keller, Moosinning (DE); Trevor C. Jones, Mainburg (DE)

(73) Assignee: TEXAS INSTRUMENTS INCORPORATED, Dallas, TX (US)

(21) Appl. No.: 14/275,295

(22) Filed: May 12, 2014

(51) Int. Cl. G06F 9/44

(52) U.S. Cl. CPC G06F 9/4401

(57) ABSTRACT

In an embodiment of the invention, a storage element which provides a user program is extended by logic which can detect special conditions and inject special start addresses on demand. During the read (fetch) of a start address of the user program, which is always at a fixed address for a given CPU, the conditions are used to respond to this read address either by different hardcoded addresses or by the original content of the memory.

### BACKGROUND

Microcontrollers have different startup behavior based on the conditions during startup. The evaluation of different constraints during startup can delay the start of a user program operating on a microcontroller. This delay can be reduced by partially offloading the task of evaluating different constraints during startup to hardware along with moving software evaluation to a non-critical timing path of execution.

### BRIEF DESCRIPTION OF THE DRAWINGS

FIG. 1 is a flow diagram illustrating a method of reducing delay of a start of a user program operating on a microcontroller according to an embodiment of the invention.

### DETAILED DESCRIPTION

In an embodiment of the invention, a storage element which provides a user program is extended by logic which can detect special conditions and inject special start addresses on demand. During the read (fetch) of a start address of the user program, which is always at a fixed address for a given CPU, the conditions are used to respond to this read address either by different hardcoded addresses or by the original content of the memory.

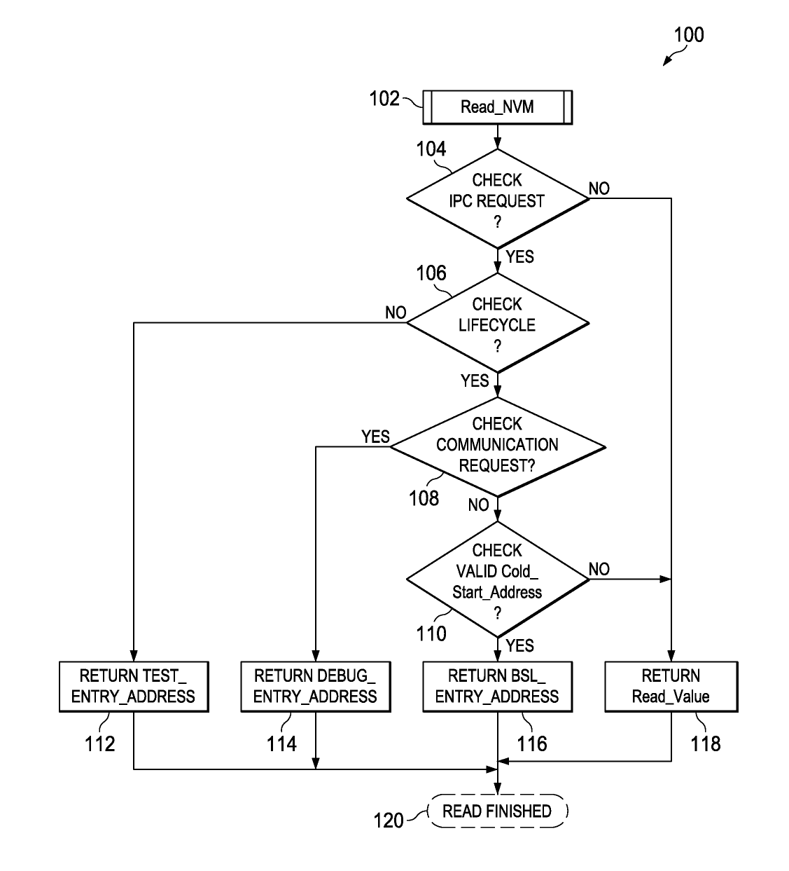

FIG. 1 is a flow diagram illustrating a method 100 of reducing delay of a start of a user program operating on a microcontroller according to an embodiment of the invention. At step 102 storage (in this example non-volatile memory (NVM), provides the user code. At step 104 the method determines whether an inter-process communication (IPC) has occurred. When an IPC request has occurred, the method moves to step 106. When an IPC request has not occurred, a read value is returned 118 and the read is finished 120. During step 106 the method checks the lifecycle 106 (i.e. is the system ready). When the system is ready, the method moves to step 108. When the system is not ready, the method returns a test entry address 112 and the read is finished 120. During step 108, the method checks for a communication request (e.g. a JTAG Mailbox Flag is set). When a communication request is found, the method returns a debug entry address 114 and the read is finished 120. When a communication request is not found, the method moves to step 110.

At step 110 the method checks for a valid cold start address. When a valid cold start address is detected, the method returns a BSL entry address 116 and the read is finished 120. When a valid cold start address is not detected, the method returns a return read value 118 and the read is finished 120.

What is claimed is:

1. A method for reducing startup time of a microcontroller comprising:
reading user code from storage;
determining when an inter-process communication (IPC) has occurred;
wherein when an IPC has not occurred, a read value is returned and the read is finished;
wherein when an IPC has occurred, determining whether a system is ready;
wherein when the system is not ready, a test entry address is returned and the read is finished;
wherein when the system is ready, determining whether a communication request has been made;
wherein when the communication request had been made, a debug entry address is returned and the read is finished
wherein when the communication request has not been made, determining whether a valid cold start address has been provided;
wherein when a valid cold start address has not been provided, a read value is returned and the read is finished; and
wherein when a valid cold start address has been provided, a BSL entry address is provided and the read is finished.

2. The method of claim 1 wherein the storage comprises a non-volatile memory.
